(19) United States
(12) Patent Application Publication
(10) Pub. No.: US 2026/0204699 A1
(43) Pub. Date: Jul. 16, 2026

(54) Prismatic Secondary Battery Including Venting Device

(71) Applicant: LG Energy Solution, Ltd., Seoul (KR)

(72) Inventors: Won Mo Hwang, Daejeon (KR); Yong Hwan Ro, Daejeon (KR); Shin Young Park, Daejeon (KR); Tae Won Hwang, Daejeon (KR); Yong Hun Lee, Daejeon (KR)

(73) Assignee: LG Energy Solution, Ltd., Seoul (KR)

(21) Appl. No.: 19/443,741

(22) Filed: Jan. 8, 2026

(30) Foreign Application Priority Data
Jan. 13, 2025 (KR) 10-2025-0004741

(51) Int. Cl. H01M 50/143; B60L 50/64; H01M 50/103; H01M 50/15; H01M 50/249; H01M 50/342; H01M 50/474

(52) U.S. Cl. CPC H01M 50/143; H01M 50/103; H01M 50/15; H01M 50/249; H01M 50/3425; H01M 50/474; B60L 50/64; H01M 2220/20

(57) ABSTRACT

A prismatic secondary battery includes a cap plate provided on an upper surface of a housing and including an electrode terminal; a venting device provided on a lower surface of the housing; and an electrode assembly accommodated inside the housing. An upper structure is provided inside the housing and configured to fill a space between the electrode assembly and the cap plate.

### CROSS-REFERENCE TO RELATED APPLICATIONS

This application is based on and claims priority from Korean Patent Application No. 10-2025-0004741 filed on Jan. 13, 2025, with the Korean Intellectual Property Office, the disclosure of which is incorporated herein in its entirety by reference.

### TECHNICAL FIELD

The present disclosure relates to a prismatic secondary battery.

### BACKGROUND

Unlike primary batteries, secondary batteries are rechargeable, and are capable of both being miniaturized and achieving high capacity, and thus have been researched and developed in various directions. As technological development and demand for mobile devices increase, and as electric vehicles and energy storage systems have been highlighted in response to the demands of the times for environmental protection, demand for secondary batteries as energy sources is increasing more rapidly.

According to the shape of the battery case, secondary batteries are classified into various types including coin-type batteries, cylindrical batteries, prismatic batteries, and pouch-type batteries. In a secondary battery, an electrode assembly mounted inside the battery case is a power-generating device capable of charging and discharging, and has a stacked structure of electrodes and separators. The electrode assembly may be roughly classified into a jelly roll type in which a separator is interposed between sheet-type positive electrodes and negative electrodes coated with active materials and wound, a stack type in which a plurality of positive electrodes and negative electrodes are sequentially stacked with separators interposed therebetween, and a stack-and-folding type in which unit cells of the stack type are wound with an extended-length separator.

Although prismatic secondary batteries provide relatively high energy density, there is a corresponding concern regarding structural stability, which remains a problem to be addressed. For example, a technology intended to suppress an increase in electrical resistance by minimizing welding portions for connecting terminals and an internal electrode assembly has been disclosed, and Korean Patent Application Publication No. 2019-0102816 may be referred to as an example thereof.

### SUMMARY

The present disclosure provides a prismatic secondary battery including an auxiliary mechanism that facilitate the operation of the venting device when a thermal event occurs.

However, the technical problems to be solved by the present disclosure are not limited to those described above, and other problems not mentioned will be clearly understood by those skilled in the art from the following description of the disclosure.

The present disclosure provides a prismatic secondary battery including: a housing; a cap plate provided on an upper surface of the housing and including an electrode terminal; a venting device provided on a lower surface of the housing; and an electrode assembly accommodated inside the housing, in which an upper structure is provided inside the housing and configured to fill a space between the electrode assembly and the cap plate.

The upper structure may be an injection-molded product made of a resin material.

The upper structure may be made of an electrically insulating resin material.

In one embodiment, the upper structure may be filled with an expandable flame retardant therein.

The expandable flame retardant may form a thermal insulation layer by expansion due to heat when a temperature inside the housing exceeds a preset temperature.

In one embodiment, a lower structure may be provided on an inner bottom surface of the housing and configured to surround the venting device and support the electrode assembly, and a plurality of through-holes may be formed in the lower structure.

The lower structure may be provided with an insulating protective layer on a surface in contact with the electrode assembly.

The protective layer may be configured such that a portion covering the plurality of through-holes is ruptured when an external pressure corresponding to an operating pressure of the venting device is applied, or may be melted when a temperature inside the housing exceeds the preset temperature.

The lower structure may be an arch-shaped structure surrounding the venting device and support the electrode assembly by contact with a portion of a lower surface of the electrode assembly.

The lower structure may be a bent structure surrounding the venting device and support the electrode assembly by contact with a portion of a lower surface or an entire lower surface of the electrode assembly.

The upper structure may partially include an electrical conductor and electrically connect an electrode lead of the electrode assembly and the electrode terminal of the cap plate.

The upper structure may be made of a gas-impermeable material and block gas generated from the electrode assembly from contacting the electrode terminal.

The expandable flame retardant may fill a space inside the housing during expansion, thereby discharging gas and electrolyte to an outside through the venting device to terminate an electrochemical reaction.

The lower structure may be formed of a metal material having structural rigidity.

The venting device may include a rupture disk formed by processing a notch in a plate made of a metal material, and may be opened as the notch is ruptured when internal pressure of the housing increases.

A battery pack according to one embodiment of the present disclosure may include the prismatic secondary battery.

A vehicle according to one embodiment of the present disclosure may include the battery pack.

In the prismatic secondary battery of the present disclosure, when a large amount of gas is generated from an electrode assembly immersed in an electrolyte due to occurrence of a thermal event such as thermal runaway, the gas is prevented from flowing toward an electrode terminal by an upper structure that fills a space between the electrode assembly and a cap plate, and instead flows toward a venting device on a lower side. Accordingly, as pressure of the gas is rapidly applied to the venting device, the venting device operates at an early stage of occurrence of the thermal event.

In addition, since inflow of high-temperature gas into the electrode terminal where current is concentrated is significantly reduced, problems such as flames jetting upward from the prismatic secondary battery are prevented or suppressed.

In view of the above, the prismatic secondary battery of the present disclosure including the upper structure that fills the space between the electrode assembly and the cap plate exhibits improved safety upon occurrence of a thermal event.

However, technical effects obtainable through the present disclosure are not limited to the above-described effects, and other effects not mentioned will be clearly understood by a person having ordinary skill in the art from the following description of the present disclosure.

### BRIEF DESCRIPTION OF THE DRAWINGS

The following drawings attached hereto illustrate embodiments of the present disclosure and serve to further understand the technical idea of the present disclosure together with the detailed description of the disclosure to be described later. Therefore, the present disclosure should not be construed as being limited to the matters illustrated in the drawings.

FIG. 1 is a perspective view illustrating an outer appearance of a prismatic secondary battery according to one embodiment of the present disclosure.

FIG. 2 is a cross-sectional view taken along line A-A of FIG. 1.

FIG. 3 is a cross-sectional view according to another embodiment of an upper structure of FIG. 2.

FIG. 4 is a cross-sectional view illustrating a prismatic secondary battery according to another embodiment of the present disclosure.

FIG. 5 is a cross-sectional view illustrating a prismatic secondary battery according to still another embodiment of the present disclosure.

FIG. 6 is a perspective view illustrating an example of a lower structure provided in the prismatic secondary battery of FIG. 5.

FIG. 7 is a perspective view illustrating another example of the lower structure.

FIG. 8 is a cross-sectional view illustrating a prismatic secondary battery to which the lower structure of FIG. 7 is applied.

FIG. 9 is a perspective view illustrating a battery pack including a prismatic secondary battery according to one embodiment of the present disclosure and a vehicle.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

The present disclosure is susceptible to various modifications and various embodiments, and specific embodiments will be described below.

However, this is not intended to limit the present disclosure to specific embodiments, but should be understood to include all modifications, equivalents, or substitutes included in the spirit and the technical scope of the present disclosure.

As used herein, it should be understood that the terms “comprise,” “include,” or “have,” etc., are intended to specify the presence of a feature, number, step, operation, component, part, or combination thereof, but do not exclude in advance the possibility of the presence or addition of one or more other features, numbers, steps, operations, components, parts, or combinations thereof.

In addition, in the present disclosure, when a portion such as a layer, a film, a region, or a plate is described as being “on” another portion, this includes not only a case where the portion is located directly on the other portion, but also a case where still another portion is interposed therebetween. Conversely, when a portion such as a layer, a film, a region, or a plate is described as being “under” the other portion, this includes not only a case of being “directly under” the other portion, but also a case where there is another portion in between. In addition, in the present application, a description that a portion is disposed “on” another portion may include not only a case where the portion is disposed above the other portion but also a case where the portion is disposed below the other portion.

Since conventional prismatic secondary batteries have high energy density, a housing thereof is designed to have an increased thickness for safety. However, when a thermal event such as thermal runaway occurs and an explosion takes place due to the increased thickness of the housing, damage therefrom may be severe. Accordingly, prismatic secondary batteries are provided with a venting device to prevent or suppress an explosion, and in order to enhance safety of the prismatic secondary batteries, it should be ensured with high reliability that the venting device operates smoothly.

In consideration of the above, the present disclosure provides a prismatic secondary battery including an auxiliary mechanism that facilitate the operation of the venting device when a thermal event occurs.

The present disclosure provides a prismatic secondary battery including: a cap plate provided on an upper surface of a housing and including an electrode terminal; a venting device provided on a lower surface of the housing; and an electrode assembly accommodated inside the housing, in which an upper structure is provided inside the housing and configured to fill a space between the electrode assembly and the cap plate.

In the prismatic secondary battery of the present disclosure, when a large amount of gas is generated from an electrode assembly immersed in an electrolyte due to occurrence of a thermal event such as thermal runaway, the gas is prevented from flowing toward an electrode terminal by an upper structure that fills a space between the electrode assembly and a cap plate, and instead flows toward a venting device on a lower side. Accordingly, as pressure of the gas is rapidly applied to the venting device, the venting device operates at an early stage of occurrence of the thermal event.

In addition, since inflow of high-temperature gas into the electrode terminal where current is concentrated is significantly reduced, problems such as flames jetting upward from the prismatic secondary battery are prevented or suppressed.

In view of the above, the prismatic secondary battery of the present disclosure including the upper structure that fills the space between the electrode assembly and the cap plate exhibits improved safety upon occurrence of a thermal event.

Hereinafter, embodiments of a prismatic secondary battery 10 of the present disclosure will be described with reference to the accompanying drawings. For reference, in the following description, directions indicating relative positions, such as front, rear, upper, lower, left, and right directions, are provided for convenience of understanding the present disclosure, and unless otherwise defined, are based on directions illustrated in the drawings.

### First Embodiment

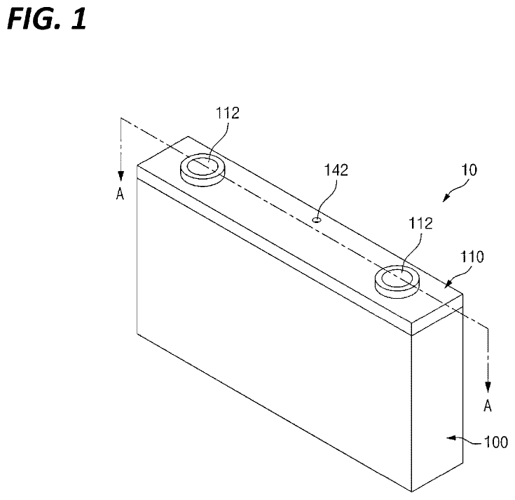

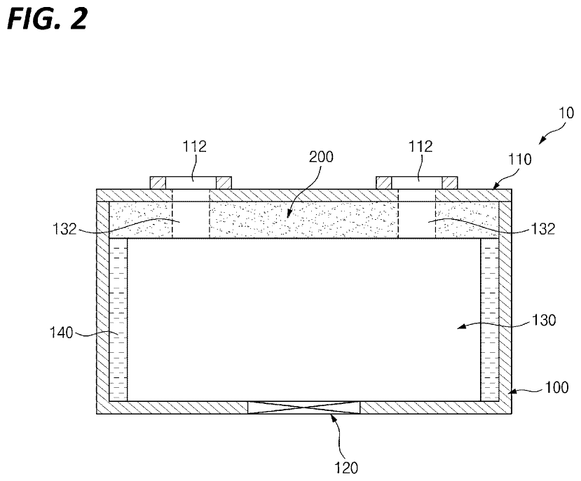

FIG. 1 is a perspective view illustrating an outer appearance of a prismatic secondary battery 10 according to one embodiment of the present disclosure. The illustrated prismatic secondary battery 10 includes a housing 100 formed in a hexahedral shape and having an open upper surface, an electrode assembly 130 accommodated in the housing 100, and a cap plate 110 that serves as a cover closing the upper surface of the housing 100 and is provided with a pair of electrode terminals 112 corresponding to a positive electrode and a negative electrode. An electrolyte 140 is injected into the housing 100 such that the electrode assembly 130 is immersed therein, and the cap plate 110 may be provided with an electrolyte injection port 142 through which the electrolyte 140 (see, e.g., FIG. 2) is injected. In addition, a venting device 120 (see, e.g., FIG. 2) is provided on a lower surface of the housing 100.

The prismatic secondary battery 10 of FIG. 1 is merely one example, and the prismatic secondary battery 10 of the present disclosure is basically configured such that the electrode terminals 112 are disposed on the upper surface of the housing 100 and the venting device 120 is provided on the lower surface of the housing 100. The electrode assembly 130 may be a jelly-roll type, a stack type, or a stack-and-folding type, and the form factor such as width, thickness, and height of the hexahedral shape may also vary without limitation. However, the above-described upper and lower positional relationship is relative and reflects the illustrated orientation, and in some cases, the present disclosure may also be applied to a prismatic secondary battery 10 in which the pair of electrode terminals 112 and the venting device 120 are separately disposed on opposing surfaces.

FIG. 2 is a cross-sectional view taken along line “A-A” of FIG. 1. The pair of electrode terminals 112 provided on the cap plate 110 are electrically connected to a pair of electrode leads 132 provided on the electrode assembly 130. In addition, the venting device 120 is provided on the lower surface of the housing 100.

The venting device 120 corresponds to a device functioning as a safety valve that ruptures to release internal pressure when pressure exceeding a safety level is applied inside the prismatic secondary battery 10. For example, when the electrode assembly 130 is overheated due to an abnormal event such as thermal runaway and a large amount of gas is generated, internal pressure of the housing 100 sharply increases, and in this case, the venting device 120 may be opened for safety. Various specifications may be applied to the venting device 120, and for example, the venting device 120 may include a rupture disk formed by processing a notch in a thin plate-shaped member made of a metal material. When internal pressure of the sealed prismatic secondary battery 10 increases, tensile deformation occurs over the entire thin plate due to the pressure, and a notch portion having relatively low strength is torn and opened, thereby relieving excessive internal pressure of the prismatic secondary battery 10.

In order for the venting device 120 to operate smoothly and accurately under a preset pressure condition, the pressure inside the housing 100 needs to be rapidly applied to the venting device 120. However, since gas has a tendency to rise due to buoyancy, high-temperature gas preferentially moves toward the cap plate 110. The electrode terminals 112 of the prismatic secondary battery 10 in which a thermal event has occurred may be overheated due to current concentration, and when the gas reacts with the high-temperature electrode terminals 112 to cause ignition or explosion, structural collapse of the prismatic secondary battery 10 may occur before the venting device 120 operates. Accordingly, it is necessary to design the venting device 120 to operate in a timely manner in consideration of such gas flow and temperature distribution in order to maintain structural stability of the prismatic secondary battery 10.

In the present disclosure, in order to allow the venting device 120 to operate rapidly and accurately, an upper structure 200 is provided inside the housing 100 so as to fill a space between the electrode assembly 130 and the cap plate 110. By occupying the space between the electrode assembly 130 and the cap plate 110, the upper structure 200 blocks flow of gas moving toward the cap plate 110 when a thermal event occurs. Accordingly, the gas flows downward, and the internal pressure of the housing 100 is rapidly applied to the venting device 120. In this structural context, the upper structure 200 assists activation of the venting device 120 more efficiently.

The upper structure 200 may be an injection-molded product made of a resin material, and may be made of an electrically insulating resin material. As the upper structure 200 has electrical insulation, an insulating structure between the electrode assembly 130 and the cap plate 110 may be further reinforced.

In addition, the upper structure 200 may be gas-impermeable. By preventing gas from passing therethrough, the upper structure 200 may effectively suppress contact between the electrode terminals 112 and the gas.

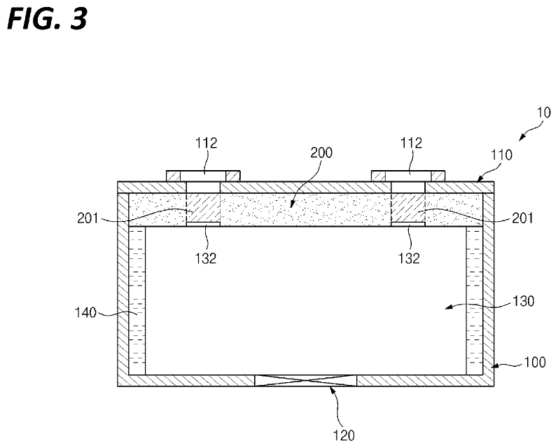

FIG. 3 is a cross-sectional view illustrating another embodiment of the upper structure 200 illustrated in FIG. 2. Referring to FIG. 3, the upper structure 200 according to the present embodiment may partially include an electrical conductor 201. The electrical conductor 201 may be made of a metal material having excellent conductivity, and may relay electrical connection between the electrode leads 132 of the electrode assembly 130 and the electrode terminals 112 of the cap plate 110.

For example, the electrode leads 132 and the electrode terminals 112 may have a structure in which the electrode leads 132 and the electrode terminals 112 do not physically directly contact each other or are not welded to each other. In this case, the electrical conductor 201 partially included in the upper structure 200 may be electrically connected to the electrode leads 132 and the electrode terminals 112, thereby forming an electrical connection path. Through this configuration, flexibility in arrangement of the electrode leads 132 may be increased and efficiency of an assembly process may be improved.

### Second Embodiment

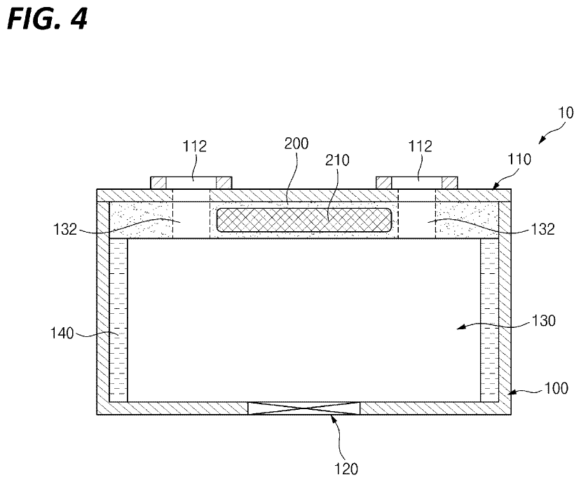

FIG. 4 is a cross-sectional view illustrating a prismatic secondary battery 10 according to another embodiment of the present disclosure. In the embodiment of FIG. 4, an upper structure 200 is filled with an expandable flame retardant 210 therein.

The expandable flame retardant 210 has a property of foaming when exposed to heat, and may normally maintain a solid state without fluidity. When a high temperature is applied to the upper structure 200 due to occurrence of a thermal event, the expandable flame retardant 210 undergoes foaming expansion due to heat. When exposed to high temperature, the expandable flame retardant 210 expands to a volume several tens of times larger, ruptures thin wall portions of the upper structure 200, and is discharged, thereby forming a thermal insulation layer around the cap plate 110. The foaming expansion occurs when a temperature inside the housing 100 exceeds a preset temperature, leading to formation of the thermal insulation layer. The expanded thermal insulation layer may delay heat transfer to the cap plate 110 for a predetermined period of time, thereby suppressing occurrence of problems such as flames being ejected upward from the prismatic secondary battery 10.

In addition, as the expandable flame retardant 210 expands and the thermal insulation layer fills an internal space of the housing 100, pressure applied to the venting device 120 rapidly increases, thereby promoting rapid operation of the venting device 120. Further, after operation of the venting device 120, expansion of the expandable flame retardant 210 may serve to rapidly discharge not only the gas but also the electrolyte 140 through the venting device 120 located on a lower surface of the housing 100. By rapid discharge of the electrolyte 140, an electrochemical reaction inside the housing 100 that caused the thermal event may be rapidly terminated.

### Third Embodiment

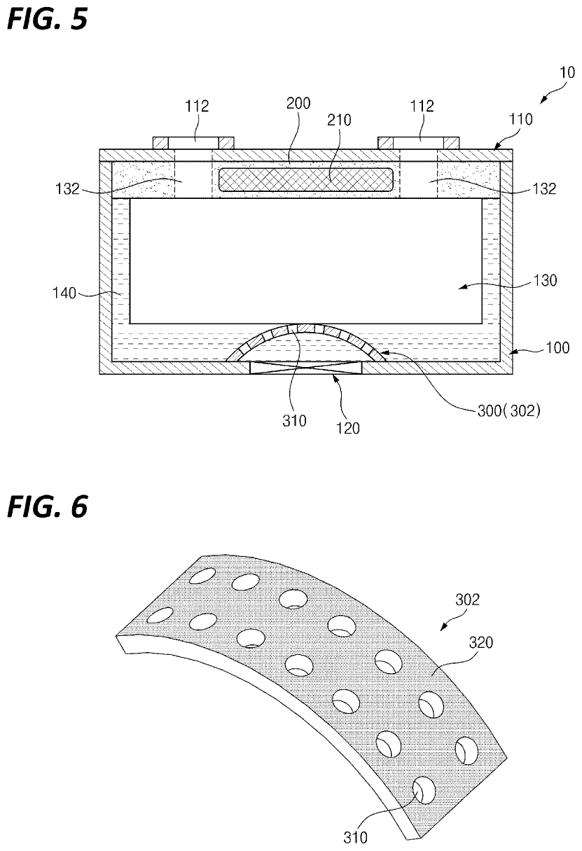

FIG. 5 is a cross-sectional view illustrating a prismatic secondary battery 10 according to still another embodiment of the present disclosure, and FIG. 6 is a perspective view illustrating one example of a lower structure 300 provided in the prismatic secondary battery 10 of FIG. 5. In the embodiments of FIGS. 5 and 6, a lower structure 300 is provided on the inner bottom surface of a housing 100 to surround a venting device 120 and supports an electrode assembly 130. Here, a plurality of through-holes 310 is formed in the lower structure 300.

Since the venting device 120 is positioned on the lower surface of the housing 100, the electrode assembly 130 may cover a portion or all of the venting device 120. When the electrode assembly 130 covers the venting device 120, pressure of gas may not be properly applied to the venting device 120. The lower structure 300 forms a space around the venting device 120 in which gas pressure may act, thereby allowing the pressure of the gas to be applied to the venting device 120. For example, since the plurality of through-holes 310 is formed in the lower structure 300, application of gas pressure to the venting device 120 is not hindered.

The lower structure 300 may be provided with an insulating protective layer 320 on a surface contacting the electrode assembly 130. In consideration of structural rigidity and durability, the lower structure 300 may be made of a metal material. In this case, insulation of the lower structure 300 supporting the electrode assembly 130 may be required. The insulating protective layer 320 provides electrical insulation to the lower structure 300 made of the metal material.

However, when the protective layer 320 covers the through-holes 310 that impart air permeability to the lower structure 300, the air permeability may be reduced. Accordingly, the protective layer 320 may be processed to have a plurality of openings communicating with the plurality of through-holes 310. Alternatively, in order to avoid issues such as time and cost associated with perforation processing of the protective layer 320, a protective layer 320 made of a material may be applied, the material being naturally ruptured by pressure when an external pressure corresponding to an operating pressure of the venting device 120 is applied to portions covering the through-holes 310, or that is melted when a temperature inside the housing 100 exceeds a preset temperature.

The lower structure 300 illustratively shown in FIG. 6 is formed as an arch-shaped structure 302 surrounding the venting device 120. By forming the lower structure 300 in an arch shape that is resistant to external pressure, the electrode assembly 130 may be firmly supported, and the venting device 120 may be safely protected even when the internal pressure of the housing 100 sharply increases due to occurrence of a thermal event.

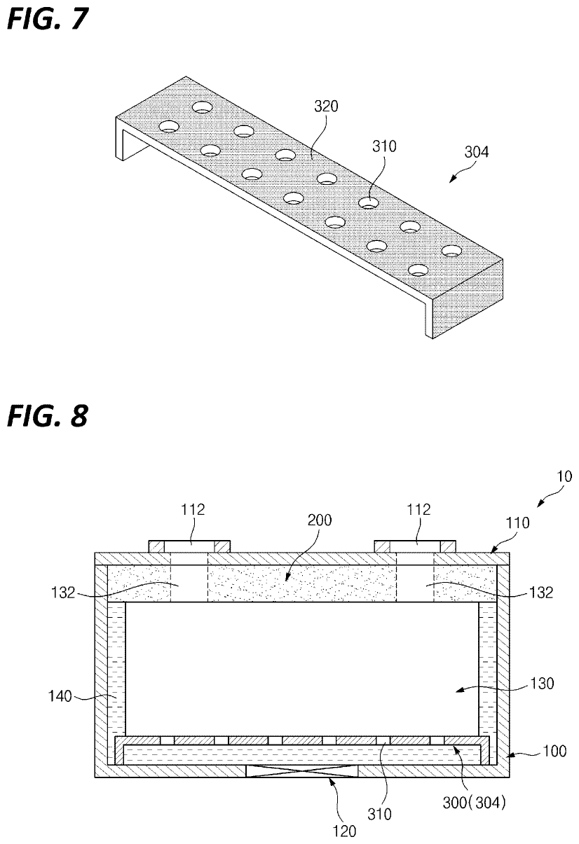

The arch-shaped lower structure 300 supports the electrode assembly 130 by contacting a portion of the electrode assembly 130. FIG. 7 is a perspective view illustrating another example of the lower structure 300, and FIG. 8 is a cross-sectional view illustrating a prismatic secondary battery 10 to which the lower structure 300 of FIG. 7 is applied. In the illustrative examples of FIG. 7 and FIG. 8, the lower structure 300 may support the electrode assembly 130 by contacting a portion of a lower surface or an entire lower surface of the electrode assembly 130.

In the lower structures 300 of FIGS. 7 and 8, two opposing edges are bent. The bent portions serve as legs of the lower structure 300, and such a lower structure 300 may be referred to as a bent structure 304. The bent lower structure 300 also forms a space around the venting device 120 in which gas pressure may act. In addition, by designing a length of the lower structure 300 to correspond to an overall length or an overall width of the electrode assembly 130, the lower structure 300 may support the electrode assembly 130 by contacting the entire lower surface thereof. As the contact area increases, a load applied to the lower structure 300 may be distributed, and thus structural stability of the lower structure 300 may be improved.

The bent lower structure 300 is also formed with a plurality of through-holes 310, and may also be provided with an insulating protective layer 320 on a surface contacting the electrode assembly 130.

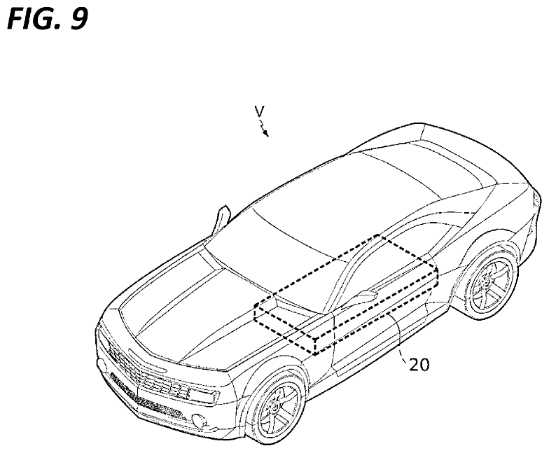

FIG. 9 is a view illustrating a battery pack and a vehicle according to one embodiment of the present disclosure.

One embodiment of the present disclosure provides a battery pack 20 including the prismatic secondary battery. Since the battery pack 20 includes the secondary battery having high capacity, high rate capability, and cycle characteristics, the battery pack 20 may be used as a power source for medium-and large-sized devices selected from electric vehicles, hybrid electric vehicles, plug-in hybrid electric vehicles, and energy storage systems.

The battery pack 20 and the vehicle V according to this embodiment include the prismatic secondary battery 10 of the foregoing embodiments, and thus may implement a battery pack 20 and a vehicle V having all advantages achieved through the prismatic secondary battery 10 of the foregoing embodiments.

In addition, the battery pack 20 may be provided not only in the vehicle V but also in other devices, apparatuses, or facilities using secondary batteries, such as power storage devices.

As described above, the present disclosure has been described with reference to the drawings and embodiments. However, configurations described in the drawings or embodiments set forth in the present specification are merely examples of embodiments of the present disclosure and do not represent all of the technical ideas of the present disclosure, and thus it should be understood that various equivalents and modifications capable of replacing the same may exist at the time of filing of the present application.

What is claimed is:

1. A prismatic secondary battery comprising:
a housing;
a cap plate provided on an upper surface of the housing and including an electrode terminal;
a venting device provided on a lower surface of the housing; and
an electrode assembly accommodated inside the housing,
wherein an upper structure is provided inside the housing and configured to fill a space between the electrode assembly and the cap plate.

2. The prismatic secondary battery according to claim 1, wherein the upper structure is an injection-molded product made of a resin material.

3. The prismatic secondary battery according to claim 2, wherein the upper structure is made of an electrically insulating resin material.

4. The prismatic secondary battery according to claim 1, wherein the upper structure is filled with an expandable flame retardant therein.

5. The prismatic secondary battery according to claim 4, wherein the expandable flame retardant forms a thermal insulation layer by expansion due to heat when a temperature inside the housing exceeds a preset temperature.

6. The prismatic secondary battery according to claim 1, wherein a lower structure is provided on an inner bottom surface of the housing and configured to surround the venting device and support the electrode assembly, and
a plurality of through-holes is formed in the lower structure.

7. The prismatic secondary battery according to claim 6, wherein the lower structure is provided with an insulating protective layer on a surface in contact with the electrode assembly.

8. The prismatic secondary battery according to claim 7, wherein the protective layer is configured such that a portion covering the plurality of through-holes is ruptured when an external pressure corresponding to an operating pressure of the venting device is applied, or is melted when a temperature inside the housing exceeds the preset temperature.

9. The prismatic secondary battery according to claim 6, wherein the lower structure is an arch-shaped structure surrounding the venting device and supports the electrode assembly by contact with a portion of a lower surface of the electrode assembly.

10. The prismatic secondary battery according to claim 6, wherein the lower structure is a bent structure surrounding the venting device and supports the electrode assembly by contact with a portion of a lower surface or an entire lower surface of the electrode assembly.

11. The prismatic secondary battery according to claim 1, wherein the upper structure partially includes an electrical conductor and electrically connects an electrode lead of the electrode assembly and the electrode terminal of the cap plate.

12. The prismatic secondary battery according to claim 1, wherein the upper structure is made of a gas-impermeable material and blocks gas generated from the electrode assembly from contacting the electrode terminal.

13. The prismatic secondary battery according to claim 4, wherein the expandable flame retardant fills a space inside the housing during expansion, thereby discharging gas and electrolyte to an outside through the venting device to terminate an electrochemical reaction.

14. The prismatic secondary battery according to claim 6, wherein the lower structure is formed of a metal material having structural rigidity.

15. The prismatic secondary battery according to claim 1, wherein the venting device includes a rupture disk formed by processing a notch in a plate made of a metal material, and is opened as the notch is ruptured when internal pressure of the housing increases.

16. A battery pack comprising the prismatic secondary battery according to claim 1.

17. A vehicle comprising the battery pack according to claim 16.
